(19) United States
(12) Patent Application Publication
(10) Pub. No.: US 2023/0060365 A1
(43) Pub. Date: Mar. 2, 2023

(54) Windows With Uniform Thicknesses

(71) Applicant: Apple Inc., Cupertino, CA (US)

(72) Inventors: David E Kingman, San Francisco, CA (US); Albert J Golko, Saratoga, CA (US); Dale N Memering, New York, NY (US); Zhiyong C Xia, San Jose, CA (US)

(21) Appl. No.: 17/859,250

(22) Filed: Jul. 7, 2022

Related U.S. Application Data
(60) Provisional application No. 63/236,600, filed on Aug. 24, 2021.

(51) Int. Cl. B60J 1/00; B32B 7/023; B32B 3/26; B32B 17/10

(52) U.S. Cl. CPC B60J 1/008; B32B 7/023; B32B 3/263; B32B 17/10036; B32B 17/10495; B32B 2307/42; B32B 2307/732; B32B 2605/00; B32B 2250/03; B32B 2250/40

(57) ABSTRACT

A system may have a window. The system may be a vehicle having a vehicle body. The window may serve as a front window in the vehicle body, a rear window in the vehicle body, a side or roof window, or other window. A window may include one or more structural glass layers. A layer of polymer may be used to attach glass layers together. An electrically adjustable component such as a light modulator layer may be included between structural glass layers. The glass layers may be characterized by regions of compound curvature. To ensure satisfactory optical performance, the window layers may be formed from molded sheets of glass that are shaped in a molding tool with draw beads of various strengths. The molded glass layers may exhibit low amounts of thickness variation.

This application claims the benefit of provisional patent application No. 63/236,600, filed Aug. 24, 2021, which is hereby incorporated by reference herein in its entirety.

### FIELD

This relates generally to structures that pass light, and, more particularly, to windows.

### BACKGROUND

Windows are used in buildings and vehicles. Windows may be formed from glass or other transparent material.

### SUMMARY

A system such as a vehicle may be provided with windows. The windows may be mounted in a vehicle body and may include a front window, a rear window, side windows, roof windows, and/or other windows.

Each window may include one or more structural glass layers. A layer of polymer may be used to attach glass layers together. An electrically adjustable component such as a light modulator layer may be included between the structural glass layers.

The glass layers may be characterized by regions of compound curvature. To ensure satisfactory optical performance, the window layers may be formed from molded sheets of glass that are shaped in a molding tool with draw beads of various strengths. The molded glass layers may exhibit a high degree of uniformity, so that optical effects due to thickness variations are not readily discernible to the naked eye.

### BRIEF DESCRIPTION OF THE DRAWINGS

FIG. 1 is a diagram of an illustrative system with windows in accordance with an embodiment.

FIG. 2 is a perspective view of a portion of an illustrative window with compound curvature in accordance with an embodiment.

FIG. 3 is a cross-sectional side view of an illustrative window during window formation in accordance with an embodiment.

FIG. 4 is a cross-sectional side view of an illustrative window with multiple layers in accordance with an embodiment.

FIGS. 5A and 5B are cross-sectional side views of illustrative draw beads in window molding tools in accordance with embodiments.

FIG. 6 is a cross-sectional side view of an illustrative window layer in accordance with an embodiment.

FIGS. 7A and 7B are top views of illustrative molding tools with segmented draw beads of different strengths in accordance with embodiments.

FIG. 8 is a cross-sectional side view of an illustrative portion of a window layer in accordance with an embodiment.

### DETAILED DESCRIPTION

A system may have one or more windows. The windows may have one or more layers of molded glass. The glass layers may be molded using a molding tool with variable strength draw beads. This helps ensure that each glass layer has a uniform thickness, even when the glass layer is molded into a complex shape such as a shape with compound curvature. The uniform thickness of the glass layer reduces visible optical artifacts.

The system in which the windows are used may be a building, a vehicle, or other suitable system. Illustrative configurations in which the system is a vehicle may sometimes be described herein as an example. This is merely illustrative. Window structures may be formed in any suitable systems.

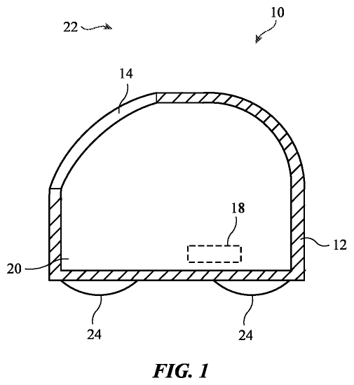

A cross-sectional side view of an illustrative system that includes windows is shown in FIG. 1. System 10 may be a vehicle, building, or other type of system. In an illustrative configuration, system 10 is a vehicle. As shown in the illustrative side view of system 10 in FIG. 1, system 10 may have support structures such as body 12. Body 12 may be a vehicle body that includes doors, trunk structures, a hood, side body panels, a roof, window pillars, and/or other body structures. Body 12 may be configured to surround and enclose an interior region such as interior region 20. System 10 may include a chassis to which wheels such as wheels 24 are mounted, may include propulsion and steering systems, and may include a vehicle automation system configured to support autonomous driving (e.g., a vehicle automation system with sensors and control circuitry configured to operate the propulsion and steering systems based on sensor data). This allows system 10 to be driven semi-autonomously and/or allows system 10 to be driven autonomously without a human operator.

One or more windows such as windows 14 may be mounted within openings in body 12. Windows 14 may, for example, be mounted on the front of body 12 (e.g., to form a front window on the front of a vehicle), on the rear of body 12 (e.g., to form a rear window at the rear of a vehicle), on the top (roof) of body 12 (e.g., to form a sun roof), and/or on sides of body 12 (e.g., to form side windows). Windows 14 may include windows that are fixed in place and/or may include windows that can be manually and/or automatically rolled up or down. For example, one or more windows 14 may be controlled using window positioners (e.g., window motors that open and close windows 14 in response to user input or other input). The area of each window 14 may be at least 0.1 m², at least 0.5 m², at least 1 m², at least 5 m², at least 10 m², less than 20 m², less than 10 m², less than 5 m², or less than 1.5 m² (as examples). Windows 14 and portions of body 12 may be used to separate interior region 20 from the exterior environment that is surrounding system 10 (exterior region 22).

System 10 may include components 18. Components 18 may include seats in the interior of body 12, sensors, control circuitry, input-output devices, and/or other vehicle components. Control circuitry in system 10 may include one or more processors (e.g., microprocessors, microcontrollers, application-specific integrated circuits, etc.) and storage (e.g., volatile and/or non-volatile memory). Input-output devices in system 10 may include displays, sensors, buttons, light-emitting diodes and other light-emitting devices, haptic devices, speakers, and/or other devices for providing output and/or gathering environmental measurements and/or user input. The sensors may include ambient light sensors, touch sensors, force sensors, proximity sensors, optical sensors, capacitive sensors, resistive sensors, ultrasonic sensors, microphones, three-dimensional and/or two-dimensional image sensors, radio-frequency sensors, and/or other sensors. Output devices may be used to provide a user with haptic output, audio output, visual output (e.g., displayed content, light, etc.), and/or other suitable output.

During operation, control circuitry in system 10 may gather information from sensors (e.g., environmental sensors) and/or other input-output devices, may gather user input such as voice commands provided to a microphone, may gather a touch command supplied to a touch sensor, may gather button input supplied to one or more buttons, etc. Control circuitry in system 10 may use this input in driving system 10 and in controlling windows and other parts of system 10.

Windows 14 may be formed from one or more glass layers. For example, two or more glass layers may be laminated together using polymer. The glass layers may be chemically or thermally tempered (e.g., to create compressive stress on the surfaces of the glass layers). The glass layers of windows 14 may sometimes referred to as structural glass layers due to the ability of such layers to provide structural support for windows 14. In some configurations, waveguide layers with light extraction features for providing in-window illumination, light modulating layers (e.g., adjustable tint layers), adjustable-haze layers, and/or other electrically adjustable window layers may be incorporated into windows 14 (e.g., such layers may be laminated between outer and inner glass layers and/or other transparent window layers).

Windows 14 may have one or more planar portions and/or one or more curved portions. As an example, one or more portions of window 14 may be characterized by a curved cross-sectional profile and may have convex and/or concave exterior surfaces (and corresponding concave and/or convex interior surfaces). Such curved portions of windows 14 may include curved surfaces that can be flattened into a plane without distortion, which are sometimes referred to as developable surfaces. Curved portions of window 14 may also include curved surfaces with compound curvature, which cannot be flattened into a plane without distortion and which are sometimes referred to as non-developable surfaces or doubly curved surfaces.

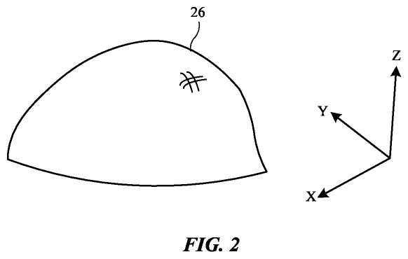

An example of a glass layer for a window having a surface with compound curvature is shown in FIG. 2. In the FIG. 2 configuration, the cross-sectional profile of glass layer 26 taken in the YZ plane is curved and the cross-sectional profile of glass layer 26 taken along a different plane such as the XZ plane is curved (e.g., layer 26 is doubly curved and exhibits compound surface curvature). The area of each glass layer 26 (and therefore each window 14) in system 10 may be at least 0.1 m², at least 0.5 m², at least 1 m², at least 5 m², at least 10 m², less than 20 m², less than 10 m², less than 5 m², or less than 1.5 m² (as examples).

To ensure satisfactory optical quality for windows 14 and thereby avoid undesired visible optical defects, the one or more glass layers that make up the windows may be formed with highly uniform thicknesses. By ensuring that thickness variations are maintained at a suitably low level, undesired visible optical defects can be avoided. Complex window shapes such as surfaces with compound curvature may be achieved by molding planar sheets of glass in a molding tool. Particularly when molding glass sheets to form glass layers with compound curvature, it can be challenging to avoid creating wrinkles and other artifacts that could degrade optical quality. To help ensure that a molded glass layer is characterized by a uniform thickness, the molding tool may be provided with draw beads that regulate the lateral flow of softened glass into the molding tool during molding. In this way, wrinkles and other undesired features associated with thickness variations can be avoided. If desired, two or more glass sheets of satisfactorily uniform thickness that are created in the molding tool may be attached together to form a multi-layer window exhibiting high optical quality. Arrangements in which windows 14 are formed from single layers of molded glass may also be used.

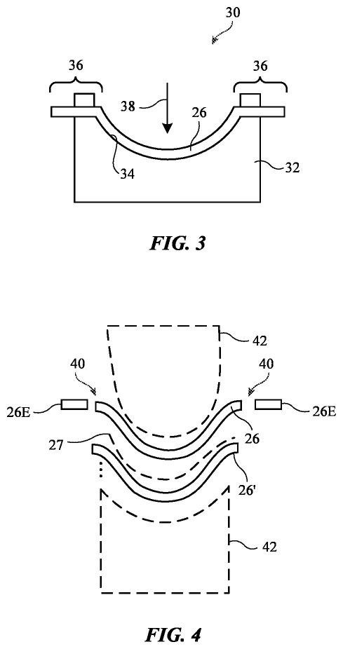

FIG. 3 is a cross-sectional side view of an illustrative molding tool for use in forming molded glass window layers. Initially, a sheet of glass is produced (e.g., a planar glass layer such as a layer of float glass of a desired thickness is produced). This glass sheet is then inserted into a molding tool such as molding tool 30 of FIG. 3. Molding tool 30 includes a heater for heating and thereby softening the glass of glass layer 26 (e.g., by heating the glass to a temperature of 700° C. or other suitable temperature). Tool 30 also includes one or more molds such as mold 32. Mold 32 in the example of FIG. 3 has a surface with compound curvature (concave surface 34). While glass layer 26 is soft due to heating, tool 30 molds glass layer 26 against surface 34. For example, tool 30 may apply a vacuum between glass layer 26 and mold 32 that draws layer 26 downwards in direction 38 against surface 34.

During this molding process, edge portions of layer 26 are drawn laterally inward past draw beads 36. Draw beads 36 run around the peripheral edge of layer 26 and are configured to allow glass layer 26 to slip through the draw beads. Draw beads 36 regulate the amount of lateral flow of glass towards the center of mold 32 as glass layer 26 is molded downwards into the curved shape of FIG. 3. This lateral flow regulation helps prevent wrinkling of glass layer 26 and helps achieve a desired thickness uniformity.

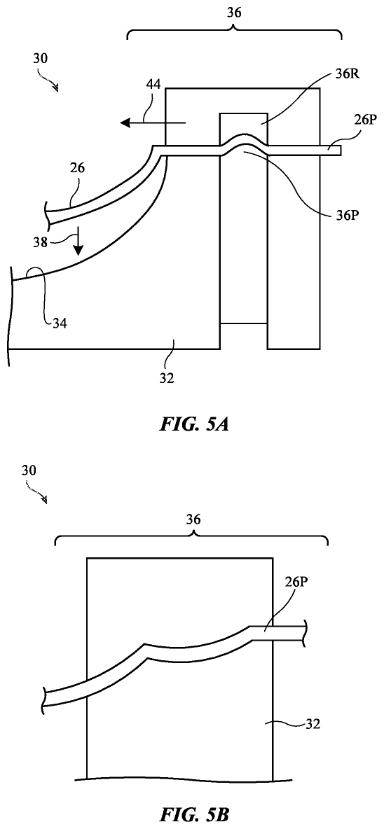

If desired, multiple layers of glass may be used in forming a window. As shown in FIG. 4, for example, after glass layer 26 has been molded into a desired shape with tool 30 of FIG. 3, lasers, water jet cutting tools, and/or other glass cutting equipment may be used to form a cut 40 around the periphery of glass layer 26, thereby trimming away edge portions 26E of layer 26. Layer 26 (e.g., an inner glass window layer) and optional additional layer(s) 26′ (e.g., an edge-trimmed outer glass window layer) may then be laminated together with polymer (see, e.g., illustrative interposed layer(s) 27). Vacuum lamination equipment may be used to attach the transparent layer of window 14 together (e.g., layers 26 and 26′) and/or the equipment used for forming windows 14 from these layers may use optional equipment 42 to press these layers together. By using glass layers of uniform thickness, window 14 may be provided with a desired high optical quality. If desired, electrically adjustable layers (e.g., one or more electrically adjustable layers in layer(s) 27) may be incorporated into window 14 (e.g., by laminating one or more such layers between respective glass layers. Layers such as layer 27 may include adjustable light transmission layers such as guest-host liquid crystal layers (sometimes referred to as light modulator layers), layers that exhibit adjustable amounts of haze (e.g., layers based on polymer-dispersed liquid crystal structures), layers that exhibit adjustable amounts of color cast, layers that exhibit adjustable amounts of polarization, and/or other electrically adjustable layer(s).

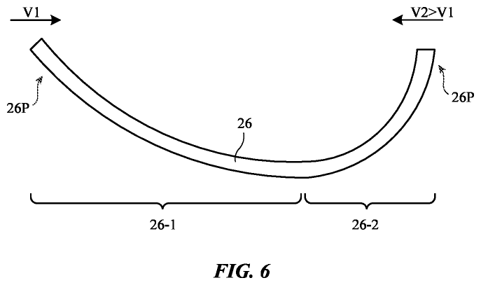

FIG. 5A is a cross-sectional side view of an illustrative draw bead for tool 30. As shown in FIG. 5A, draw bead structures such as draw bead 36 may be formed around the edge of tool 30. When the central portion of layer 26 is drawn downward in direction 38 against curved surface 34, the peripheral edge portion 26P of layer 26 is drawn inwardly to accommodate the bowing of layer 26 (e.g., edge portion 26P is drawn laterally inward through the draw bead in direction 44). Draw bead 36 may have structures such as draw bead protrusion 36P and corresponding recess 36R that interact to create a flow path with elevated resistance through which edge portion 26P is drawn. The shape and position of structures such as protrusion 36P and recess 36R may be adjustable (e.g., protrusion 36P may be formed on a member that is slidably coupled to a slot in tool 30) and/or may be fixed (e.g., protrusion 36P may form a stationary integral part of mold 32). Another illustrative draw bead arrangement is shown in FIG. 5B. In the example of FIG. 5B, draw bead 36 has a step shape rather than being formed from a protrusion. Other draw bead configurations may be used, if desired. The examples of FIGS. 5A and 5B are illustrative.

The shape and size of the draw bead structures in tool 30 may be selected so that the inward flow of glass layer peripheral edge portion 26P is at a desired level. The draw beads may exhibit different amounts of lateral flow resistance at different locations along the periphery of glass layer 26. In this way, excessive inward flow of glass may be prevented at locations such as the curved corners of a molded glass layer and/or other locations prone to glass layer wrinkling due to excessive glass.

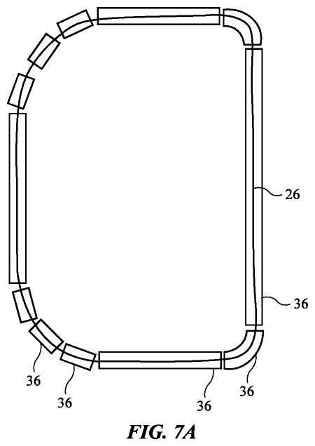

Consider, as an example, a scenario in which glass layer 26 is being molded into an asymmetric curved shape of the type shown in FIG. 6. This shape includes steeply curved portion 26-2 on the right of layer 26 and less steeply curved portion 26-1 on the right of layer 26. During glass molding, layer 26 is pulled downwards from its initial planar shape. This pulls the righthand peripheral portion 26P of layer 26 to the left through a right-hand draw bead and pulls the lefthand peripheral portion 26P of layer 26 towards the right through a lefthand draw bead. In this scenario, the draw bead on the righthand side of the mold may be configured to provide less glass flow resistance than the draw bead on the left side of the mold. As a result, glass layer portion 26P on the left side of layer 26 may flow inwardly through the lefthand draw bead at a first speed (V1), whereas glass layer portion 26P on the right side of layer 26 may flow inwardly through the righthand draw bead at a second speed (V2) that is greater than the first speed. This allows more glass to be provided to the right of layer 26 than to the left of layer 26, thereby accommodating the greater need for glass in more steeply curved portion 26-2 of layer 26 relative to that of less steeply curved portion 26-1 of layer 26 when layer 26 has been molded into its desired final shape (e.g., the asymmetric shape of FIG. 6).

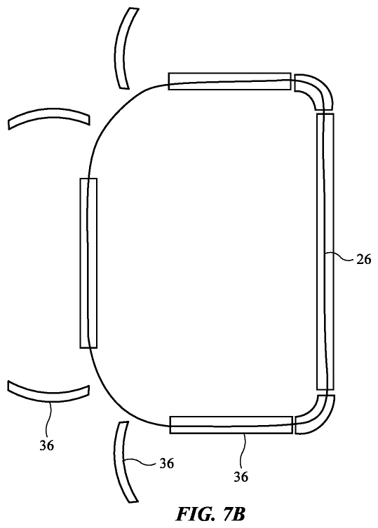

FIG. 7A is a top view of tool 30 showing how draw beads of different strengths may be provided around the periphery of layer 26. In the example of FIG. 7A, draw beads 36 are segmented, so that each segment can potentially provide a different glass flow resistance. As an example, draw bead structures at the corners of layer 26 may be configured to provide more glass flow resistance to reduce the inflow of glass at the curved molded corners of layer 26, which are at risk of wrinkling, whereas draw bead structures along the edges of layer 26 between the corners, where more glass flow is needed, may be configured to provide less glass flow resistance. As described in connection with FIG. 6, glass areas that need more glass material to be provided during molded may be supplied by lower resistance draw beads than glass areas that need less glass material during molding. If desired, the shapes and sizes of draw beads 36 may vary smoothly and continuously as a function of distance around the periphery of layer 26. In this way, draw beads 36 may exhibit a lateral glass flow resistance level that varies smoothly and continuously as a function of distance around the edge of layers 26, helping to reduce thickness variations due to undesired variations in glass flow.

In the example of FIG. 7A, draw beads 36 are located along the periphery of layer 26 (e.g., the periphery of the final desired shape of layer 26 in window 14). If desired, draw beads 36 may be distributed away from the window perimeter (see, e.g., FIG. 7B, in which draw beads 36 in the corners are located away from the periphery). Other draw bead distributions for tool 30 may be used, if desired. The examples of FIGS. 7A and 7B are illustrative.

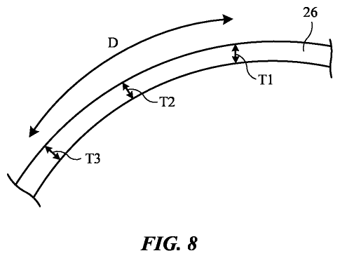

By incorporating draw beads 36 with selectively adjusted lateral glass flow resistance levels into tool 30, tool 30 may be configured to create molded glass layers with little to no observable thickness variations. As shown in FIG. 8, for example, glass layer 26 may exhibit different thicknesses T (see, e.g., illustrative thicknesses T1, T2, and T3) across a given distance D. By configuring the draw bead structures of tool 30 to satisfactorily adjust the lateral inflow of the edge portions of glass layer 26 as glass layer 26 is molded into a curved shape against surface 34 of mold 32 (e.g., a shape with surfaces of compound curvature), the variation in thickness T (difference between maximum and minimum thickness levels) per unit distance across glass layer 26 may be maintained at a sufficiently low level to prevent undesirable visible optical defects in layer(s) 26 and window 14. In an illustrative arrangement, over a lateral distance D of 20 mm across the surface of layer 26, layer 26 exhibits less than 0.7% and preferably less than 0.5% variation in thickness. The thickness of each glass layer 26 may be 0.2-3 mm, 0.2-2.5 mm, at least 0.2 mm, 0.5 mm to 4 mm, at least 0.5 mm, 1.5-1.7 mm, 1.5 to 2.5 mm, at least 0.8 mm, at least 1.2 mm, at least 1.5 mm, less than 3 mm, less than 2.5 mm, less than 2 mm, or other suitable thickness and each layer 26 may, as an example, exhibit a thickness variation of less than 15 microns per 20 mm of lateral surface distance (e.g., over most or all of layer 26).

Window 14 may include one or more glass layer 26. For windows formed from laminated safety glass, separate layers 26 of glass may be laminated together with polymer applied in a vacuum lamination tool (see, e.g., layer 27 of FIG. 4). The polymer that is used between adjacent glass layers may be polyvinyl butyral or other suitable polymer and may have a thickness of at least 0.3 mm, at least 0.6 mm, less than 0.9 mm, less than 1.1 mm, and/or other suitable thickness. If desired, multiple glass layers 26 may be attached together using heat and pressure without using interposed polymer layers. Combinations of these approaches and/or other approaches may also be used.

The foregoing is merely illustrative and various modifications can be made to the described embodiments. The foregoing embodiments may be implemented individually or in any combination.

What is claimed is:

1. A window, comprising:
a first layer of glass having a surface; and
a second layer of glass attached to the first layer of glass, wherein the first layer of glass has a curved cross-sectional profile and is characterized by a thickness variation of less than 0.5% across a distance of 20 mm along the surface.

2. The window defined in claim 1 further comprising a polymer layer between the first and second glass layers.

3. The window defined in claim 1 wherein the surface of the first layer of glass has an area of compound curvature.

4. The window defined in claim 1 wherein the first layer of glass has a thickness of 0.2 to 2.5 mm.

5. The window defined in claim 1 wherein the first layer of glass varies in thickness by less than 15 microns over a distance of 20 mm across the surface.

6. The window defined in claim 1 wherein the first and second layers of glass comprises vehicle window structural glass layers configured to separate an interior vehicle region from an exterior region.

7. A vehicle, comprising:
a vehicle body; and
a window in the vehicle body, wherein the vehicle body and the window separate an interior vehicle region from an exterior region, wherein the window has a molded glass layer, and wherein the molded glass layer has a curved cross-sectional profile that is characterized by a uniform thickness.

8. The vehicle defined in claim 7 wherein the molded glass layer has a thickness that varies by less than 0.7% over a distance along a surface of the glass layer of 20 mm.

9. The vehicle defined in claim 7 wherein the molded glass layer has an area of compound curvature.

10. The vehicle defined in claim 9 wherein the molded glass layer has a thickness that varies by less than 0.5% per 20 mm of distance along a surface of the molded glass layer within the area of compound curvature.

11. The vehicle defined in claim 10 further comprising:
an electrically adjustable layer in the window.

12. The vehicle defined in claim 11 further comprising wheels coupled to the vehicle body, wherein the window comprises a front window in the vehicle body.

13. The vehicle defined in claim 7 wherein the molded glass layer comprises a sheet of glass molded in a mold tool with draw beads characterized by different glass sheet flow resistances and wherein the molded glass layer varies in thickness by less than 15 microns over a distance of 20 mm across the molded glass layer.

14. A vehicle window configured to separate a vehicle interior region from an exterior region, the vehicle window comprising:
an outer structural glass layer; and
an inner structural glass layer coupled to the outer structural glass layer, wherein the outer and inner structural glass layers are both characterized by thickness variations of less than 0.5% over a distance of 20 mm along their surfaces.

15. The vehicle window defined in claim 14 wherein the outer structural glass layer and the inner structural glass layer have surface regions of compound curvature.

16. The vehicle window defined in claim 15 further comprising an electrically adjustable layer between the outer structural glass layer and the inner structural glass layer.

17. The vehicle window defined in claim 16 wherein the electrically adjustable layer comprises a light modulator layer.

18. The vehicle window defined in claim 15 further comprising a layer of polymer between the outer and inner structural glass layers.

19. The vehicle window defined in claim 18 wherein the outer structural glass layer has a thickness of 1.5-2.5 mm.

20. The vehicle window defined in claim 14 wherein the outer structural glass layer has a thickness of 0.2-2.5 mm, wherein the inner structural glass layer has a thickness of 0.2-2.5 mm, and wherein the outer and inner structural glass layers are both characterized by thickness variations of less than 15 microns per 20 mm along their surfaces.
